(19) United States
(12) Patent Application Publication
(10) Pub. No.: US 2007/0115133 A1
(43) Pub. Date: May 24, 2007

(54) Method of evaluating the state of alertness of a vehicle driver

(75) Inventors: Serge Boverie, Plaisance du Touch (FR); Alain Giralt, Flourens (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TOULOUSE CEDEX 1 (FR)

(21) Appl. No.: 11/600,075

(22) Filed: Nov. 16, 2006

(30) Foreign Application Priority Data
Nov. 17, 2005 (FR) 0511650

(51) Int. Cl. G08B 23/00; G06F 15/18

(52) U.S. Cl. 340/575; 706/1

(57) ABSTRACT

Method of evaluating the state of alertness of a vehicle driver based on the analysis of the eyelid movements of the driver. A classification of blink durations composed of m classes defined mathematically, and a classification of states of alertness composed of n alertness state classes including a class corresponding to an “alert” state and a class corresponding to a “sleepy” state, delimited by given thresholds of numbers of medium and long duration blinks, are set up. During an evaluation, a duration vector is associated with each blink, of which each component represents the degree of membership of the blink in one of the predefined duration classes, temporal analysis windows are defined at the end of each of which a cumulative duration vector is calculated of which each component consists of the sum ΣM,ΣL of same row components of duration vectors.

The invention relates to a method of evaluating the state of alertness of a vehicle driver, and is aimed more specifically at a method of evaluation based on the analysis of the driver's eyelid movements, being used to detect each eyelid closure, known as a blink, and to provide information representative of the duration of said blink.

Based on this principle, the essential objective of the invention is to provide a method of evaluation that can be used to achieve an on-line diagnosis of the decline in alertness of a driver from information of a physiological nature.

Another objective of the invention is to provide a method of evaluation designed to introduce levels of weighting of the diagnosis according to environmental and behavioral observations.

For this purpose, the invention is firstly aimed at a method of evaluation consisting:
in a preliminary phase:
   in establishing a classification of blink durations composed of m classes delimiting m contiguous ranges of blink duration values, consisting of at least two classes corresponding respectively to so-called medium “M”, and long “L” duration blinks, said classes being suited to describe progressive transition border zones, defined for example by using a mathematical method such as “fuzzy” logic,
   and in establishing a classification of states of alertness composed of n alertness state classes, with n≧2, comprising:
   a class corresponding to an “alert” state, defined by a number of medium duration blinks below a given threshold, and/or a number of long duration blinks below a given threshold,
   and a class corresponding to a “sleepy” state, defined by a number of medium duration blinks above a given threshold, and/or a number of long duration blinks above a given threshold,
and during the progress of an evaluation procedure:
   in associating with each blink a duration vector (m, 1) of which each component represents the degree of membership of said blink in one of the m predefined duration classes,
   in defining temporal analysis windows consisting of time intervals at the end of each of which a cumulative duration vector is calculated of which each component consists of the sum ΣM, ΣL of the same row components of duration vectors corresponding to the blinks detected during the analysis window,
   and in deducing from comparison of the calculated values ΣM and ΣL with the corresponding threshold values of the alertness states classification, information representative of the driver's alertness state.

Generally speaking, this method of evaluation is based on the observation of eyelid movements over a given time interval (analysis window), and leads to an instantaneous estimate of the driver's alertness in real time.

Furthermore, this method of evaluation consists firstly in introducing a degree of progressiveness into the blink duration classification, which leads to:
classifying each blink either in one or the other duration class, or simultaneously in two contiguous classes with a degree of membership in each of said classes between 0 and 1, the sum of these two degrees of membership being always equal to 1,
and defining each blink by a vector (m, 1) of which each component corresponds to a degree of membership in a duration class.

This method of evaluation further consists in defining a classification of alertness states designed to enable an estimate of the alertness state to be provided directly on an analysis window as a function of the number and nature of the blinks detected during this analysis window.

It should be noted for this purpose that, specifically according to the invention, each value ΣM, ΣL used to estimate the alertness state consists of the sum, on an analysis window, of the degrees of membership in a given duration class, the medium duration class and the long duration class respectively in the example.

Thus, for example for determining the value ΣM, a blink with which a degree of membership in the medium duration class equal to 1 is associated, carries the same weight as ten blinks whose degree of membership in the medium duration class is equal to 0.1.

According to an advantageous implementation of the invention, the opening of an analysis window is initiated at the time of each detection of a blink, each analysis window opened covering a specified period of time preceding said initiation.

Thus, the analysis windows are regularly refreshed, the sliding mode used for performing this refreshment ensuring that all eyelid blinks are taken into account.

In addition, with a view to ensuring a viable estimate on each analysis window, the data of an analysis window is advantageously validated if the number of blinks detected during said analysis window is higher than a given threshold.

Moreover, advantageously according to the invention, a classification of blink durations is set up composed of three classes corresponding to short duration “C”, medium duration “M” and long duration “L” blinks respectively.

Thus, by way of example, this blink duration classification may advantageously comprise:
a short duration class “C” corresponding to blink durations below a value of the order of 150 ms to 250 ms,
a medium duration class “M” corresponding to blink durations above a value of the order of 150 ms to 250 ms, and below a value of the order of 350 ms to 500 ms,
and a long duration class “L” corresponding to blink durations above a value of the order of 350 ms to 500 ms.

According to the invention, the alertness states classification in its turn advantageously comprises at least three alertness state classes:
an “alert” class defined by a number of medium duration blinks below a given threshold,
at least one intermediate class corresponding to a “drowsy” state, defined by a number of medium duration blinks above a given threshold, and by a number of long duration blinks below a given threshold,
and a “sleepy” class defined by a number of long duration blinks above a given threshold.

Advantageously, this classification is composed of four alertness state classes: the “alert” class, the “sleepy” class and two intermediate “drowsy” classes consisting of:
a first intermediate class corresponding to a “slightly drowsy” state, defined by a number of medium duration blinks above a given threshold and below a given intermediate threshold, and by a number of long duration blinks below a given threshold,
and a second intermediate class corresponding to a “drowsy” state, defined by a number of medium duration blinks above the intermediate threshold, and by a number of long duration blinks below a given threshold.

Furthermore, as for the blink duration classification the method of evaluation according to the invention advantageously consists in introducing a degree of progressiveness into the alertness states classification, with a view to taking into account any uncertainties and ambiguities in the estimates. For this purpose:
the n alertness state classes are defined so that said classes have progressive transition border zones, for example by using a mathematical method such as “fuzzy” logic,
and information is delivered representative of the driver's alertness state consisting of a vector of n alertness states of which each component represents the degree of activation of the corresponding alertness state.

According to this concept, the driver's alertness state is therefore expressed in the form of a vector of n states of which each component indicates the degree of activation of the state, i.e. the degree of membership in the corresponding class, each of said degrees of activation being between 0 and 1, and the sum of the n degrees of activation being equal to 1.

Based on this progressiveness principle, the information representative of the driver's alertness state then consists, advantageously according to the invention, of a vector of 4 alertness states of which each component represents the degree of activation of an alertness state according to the following definitions:
degree of activation of the “alert” class=f1(Σ degrees of membership in the medium duration class “M”, Σ degrees of membership in the long duration class “L”),
degree of activation of the “slightly drowsy” class=f2(Σ degrees of membership in the medium duration class “M”, Σ degrees of membership in the long duration class “L”),
degree of activation of the “drowsy” class=f3(Σ degrees of membership in the medium duration class “M”, Σ degrees of membership in the long duration class “L”),
degree of activation of the “sleepy” class=f4(Σ degrees of membership in the long duration class “L”).

According to another characteristic feature of the invention, the method of evaluation is aimed at introducing a level of confidence in the diagnosis performed. For this purpose, and advantageously according to the invention:
in a preliminary phase, each alertness state class is associated with at least one duration class regarded as determinant in the temporal representation of said alertness state class.
and during the progress of an evaluation procedure:
   the movements of both the driver's eyelids are analyzed and for each blink a comparison is made of the two signals representative of the movement of the two eyelids according to predetermined comparison criteria, such as criteria relating to the simultaneity, amplitude or slopes of said signals, so as to determine, for each blink, a degree of confidence ci representative of the correlation between the two signals,
   and for each analysis window, each piece of information incorporating an alertness state class is associated with a degree of confidence C° to be associated with this alertness state class, such that:
      C°=Σdi·ci/Σdi with:
   di degree of membership of a blink in each of the duration classes selected as determinant in the temporal representation of the alertness state class,
   ci degree of confidence of the blink.

By way of example regarding the determination of degrees of confidence, in the preliminary phase:
the short duration class is associated with the “alert” state class,
the cumulative total of the short duration and medium duration classes is associated with the “slightly drowsy” state class,
the medium duration class is associated with the “drowsy” state class,
and the long duration class is associated with the “sleepy” state class.

In addition, with a view to determining the degree of confidence associated with each blink, a combination is used advantageously according to the invention, of comparison criteria relating to the simultaneity, amplitude and slopes of the two signals representative of the movement of the two eyelids.

The method of evaluation according to the invention as defined above provides an instantaneous estimate of the driver's alertness state.

In order to complete this instantaneous estimate, and in an advantageous way according to the invention, a regular summary is made of the information delivered at the time of the last K analysis windows, with integer K predetermined, and a smoothing of the corresponding data is performed, so as to provide a summary vector of n alertness states of which each component consists of a mean summary value of the degree of activation of the corresponding alertness state.

In addition, advantageously, from the summary of the information delivered at the time of the last K analysis windows, a progress index is also determined, by a mathematical method such as the method of least squares, representative of the progress of the driver's alertness state during the last K analysis windows.

Such periodic summaries, on the one hand, enable possible unrealistic estimates to be excluded via a smoothing operation, and on the other hand, provide a progress index representative, over a long period, of the progress trend of the alertness state.

In order to complete the scope of the summary states, the degrees of confidence are further advantageously integrated into the information summary, so as to associate a mean value degree of confidence with each alertness state.

The method of evaluation according to the invention defined above is designed to carry out a diagnosis on the driver's alertness state based on physiological information alone, without calling upon other sources of information.

However, for the purposes of increasing the robustness of the method of evaluation, weighting levels are introduced at the time of diagnoses based on the analysis of eyelid movements, by advantageously integrating:
on the one hand, so-called environmental information, representative of driving conditions, such as driving time, temperature in the vehicle, time of day, type of highway (local road, freeway, city, etc.), data relating to the driver (age, experience, etc.),
on the other hand, information originating from behavioral observations, such as maintaining the direction of travel of the vehicle.

Other characteristics, objects and advantages of the invention will emerge from the detailed description that follows with reference to the accompanying drawings which show a preferential embodiment of it by way of a non-restrictive example. In these drawings:

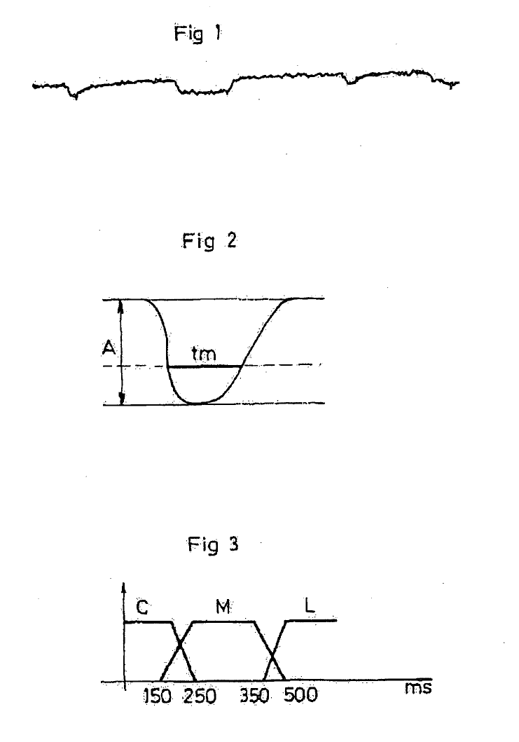

FIG. 1 is an illustration of a signal representative of closure movements of an eyelid, known as blinks,

FIG. 2 represents, on an enlarged scale, the type signature of a blink,

and FIG. 3 is a graph for determining, in fuzzy logic, the classification of blink durations.

The method according to the invention, is principally aimed at providing instantaneous estimates in real time of the driver's alertness state based on the observation of the latter's eyelid movements.

For this purpose, and in the normal way, the implementation of this method calls for sensors capable of delivering a signal, such as that shown in FIG. 1, that can be used, in a way known in itself, to detect each blink, and for each of said blinks, such as that shown in FIG. 2, to determine:
the duration tm of the blink,
the amplitude A of the blink,
and the opening and closure times defined by the slopes of the leading and trailing edges.

Firstly, the estimates are provided at the end of time intervals, called analysis windows, initiated systematically at the time of each detection of a blink, and adapted to cover and process the blinks detected over a specified time period, 30 seconds for example, preceding the initiation of the analysis window.

The first operation performed during each analysis window consists in classifying each blink according to its duration by using a blink duration classification comprising 3 classes defining short duration “C”, medium duration “M” and long duration “L” blinks respectively. In addition, these classes consist of fuzzy sets and therefore have progressive transition border zones.

By way of example, and as depicted in FIG. 3:
the short duration class “C” covers blink durations between 0 ms and 250 ms,
the medium duration class “M” covers blink durations between 150 ms and 500 ms,
and the long duration class “L” covers blink durations greater than 350 ms.

In addition, according to the fuzzy logic principle, and as depicted in FIG. 3, blinks whose duration corresponds to a border zone between two classes are simultaneously members of these two classes, the degree of membership in each of said two classes being less than 1, and the sum of said two degrees of membership being equal to 1.

This classification thus leads to defining each blink by a vector (3, 1) whose three. components correspond respectively to the degree of membership of said blink in each of the three duration classes.

After defining all the blinks detected during an analysis window, the next operation consists in determining a cumulative duration vector of which each component consists of the sum ΣC,ΣM,ΣL of the same row components of vectors defining said blinks.

According to the principle of the invention, this cumulative vector is intended to act as the basis for determining the alertness state for the analysis window concerned, through the use of an alertness states classification comprising the following four classes each defined below with the rules determining membership in said class:
a class corresponding to an “alert” state, meeting the following membership conditions: ΣL≦N1, and ΣM≦N2,
a class corresponding to a “slightly drowsy” state, meeting the following membership conditions: ΣL≦N3, and N2<ΣM≦N4,
a class corresponding to a “drowsy” state, meeting the following membership conditions: ΣL≦N3, and N4<ΣM≦N5,
and a class corresponding to a “sleepy” state, meeting the following membership conditions: ΣL>N3,
the numbers Ni above being such that Ni<Ni+1

In addition, as before, these alertness state classes are defined in such a way as to consist of fuzzy sets so that each alertness state is defined by a vector of 4 alertness states whose components represent the respective degrees of activation of the four alertness states, namely:
the degree of activation of the “alert” class=f1(Σ degrees of membership in the medium duration class “M”, Σ degrees of membership in the long duration class “L”),
the degree of activation of the “slightly drowsy” class=f2(Σ degrees of membership in the medium duration class “M”, Σ degrees of membership in the long duration class “L”),
the degree of activation of the “drowsy” class=f3(Σ degrees of membership in the medium duration class “M”, Σ degrees of membership in the long duration class “L”),
and the degree of activation of the “sleepy” class=f4(Σ degrees of membership in the long duration class “L”).

Furthermore, several techniques, known in themselves, can be used to represent the aforementioned functions fi.

Thus, a first technique may consist in defining three-dimensional fuzzy sets designed for directly obtaining the various degrees of activation without using fuzzy logic rules.

A second more conventional technique may also consist in defining one-dimensional fuzzy sets to describe each of the ΣM, ΣL inputs, and to prepare fuzzy logic rules for combining these inputs and deducing the various degrees of activation from them.

Whatever the technique used, the method of evaluation according to the invention therefore leads to providing, for each analysis window, an alertness state presented in the form of a four-state vector of which each component indicates the degree of activation of the state.

One example of alertness state provided in accordance with the invention is given below by way of illustration.

| STATE | DEGREE OF ACTIVATION |
|---|---|
| Alert | 0.2 |
| Slightly drowsy | 0.4 |
| Drowsy | 0.4 |
| Sleepy | 0 |

Another characteristic feature of the invention consists in associating a degree of confidence with each alertness state provided.

For this purpose, a degree of confidence “ci” is first assigned to each blink duration measurement. To do this, the movements of the driver's two eyelids are analyzed, and for each blink, a comparison is made of the two signals representative of the movement of the two eyelids based on predetermined comparison criteria such as:
simultaneity criteria: comparison of the duration of the signals and the times of the start and end pulses of said signals,
amplitude criteria: comparison of the signal amplitudes,
slope criteria: comparison of the respective slopes of the leading and trailing edges of the signals.

Each degree of confidence ci is thus advantageously determined from a combination of the different comparison criteria, by assigning different weights as required to the various criteria. (By way of example, normally the simultaneity criterion is thus selected as the preponderant criterion).

The confidence criteria ci calculated according to this principle are therefore such that ci=(a·Csimul+b·Camp+c·Cslope)/(a+b+c) with:
0≦Csimul, Camp, Cslope≦1
and 0≦a, b, c≦1.

Another technique for determining degrees of confidence ci may also consist in using the fuzzy logic method.

The purpose of calculating these degrees of confidence consists in associating, with each alertness state, degrees of confidence C° such that:
C° “alert”=Σdi·ci/Σdi, for all short duration blinks,
C° “slightly drowsy” =Σdi·ci/Σdi, for all short duration blinks and all medium duration blinks,
C° “drowsy” Σdi·ci/Σdi, for all medium duration blinks,
and C° “sleepy”=Σdi·ci/Σdi, for all long duration blinks.

Moreover, in these expressions:
di represents the degree of membership of a blink in the target duration class,
and ci the degree of confidence of the blink.

Another characteristic feature of the invention consists in making a regular summary or log of the information delivered at the time of the last K analysis windows, with integer K predetermined, and smoothing the corresponding data, so as to provide a summary vector of 4 alertness states of which each component consists of a mean summary value of the degree of activation of the corresponding alertness state.

In addition, the degrees of confidence are also integrated into the information summary, so as to associate a mean value degree of confidence with each alertness state.

It should be noted that according to the invention, the smoothing techniques may consist either of a simple arithmetic calculation of the mean value of the data considered, or of more complex smoothing methods of any kind known in. itself.

The summaries also have the primary function of excluding possible unrealistic estimates via a smoothing operation.

Furthermore, these summaries have the object of calculating a progress index representative of the progress of the driver's alertness state during the last K analysis windows, and therefore of the progress trend of the alertness state.

This progress index is calculated according to the common method of least squares which provides, in fact, an approximation of the interpolation slope passing through all the different points.

The method of evaluation disclosed above can be used to perform an on-line diagnosis of a driver's decline in alertness from information of a physiological nature.

It may, however, be useful to perfect the reliability of this diagnosis by weighting the latter with additional information aimed at strengthening or relaxing decision-making.

On this account, and with a view to introducing weighting levels during diagnoses based on the analysis of eyelid movements, the following are integrated:
environmental information representative of driving conditions, such as driving time, temperature in the vehicle, time of day, type of highway (local road, freeway, city, etc.), data relating to the driver (age, experience, etc.),
and information originating from behavioral observations, such as observing the direction of travel of the vehicle.

1. A method of evaluating the state of alertness of a vehicle driver, consisting in analyzing the movements of at least one eyelid of said driver so as to detect each closure of said eyelid, known as a blink, and in providing information representative of the duration of said blink, said method of evaluation being characterized in that it consists:
in a preliminary phase:
in establishing a classification of blink durations composed of m classes delimiting m contiguous ranges of blink duration values, consisting of at least two classes corresponding respectively to blinks called medium “M”, and long “L” duration [blinks], said classes being suited to describe progressive transition border zones, defined for example by using a mathematical method such as “fuzzy” logic.
and in establishing a classification of states of alertness composed of n alertness state classes, with n≧2, comprising:
a class corresponding to an “alert” state, defined by a number of medium duration blinks below a given threshold, and/or a number of long duration blinks below a given threshold,
and a class corresponding to a “sleepy” state, defined by a number of medium duration blinks above a given threshold, and/or a number of long duration blinks above a given threshold,
and during the progress of an evaluation procedure:
in associating with each blink a duration vector (m, 1) of which each component represents the degree of membership of said blink in one of the m predefined duration classes,
in defining temporal analysis windows consisting of time intervals at the end of each of which a cumulative duration vector is calculated of which each component consists of the sum ΣM,ΣL of the same row components of duration vectors corresponding to the blinks detected during the analysis window.
and in deducing from comparison of the calculated values ΣM and ΣL with the corresponding threshold values of the alertness states classification, information representative of the driver's alertness state.

2. The method of evaluation as claimed in claim 1, characterized in that:
the n alertness state classes are defined so that said classes have progressive transition border zones, for example by using a mathematical method such as “fuzzy” logic,
information is delivered representative of the driver's alertness state consisting of a vector of n alertness states of which each component represents the degree of activation of the corresponding alertness state.

3. The method of evaluation as claimed in claim 1 characterized in that a classification of blink durations is set up composed of three classes corresponding to short duration “C”, medium duration “M” and long duration “L” blinks respectively.

4. The method of evaluation as claimed in claim 1 characterized in that the alertness states classification comprises at least three alertness state classes:
an “alert” class defined by a number of medium duration blinks below a given threshold,
at least one intermediate class corresponding to a “drowsy” state, defined by a number of medium duration blinks above a given threshold, and by a number of long duration blinks below a given threshold,
and a “sleepy” class defined by a number of long duration blinks above a given threshold.

5. The method of evaluation as claimed in claim 4 characterized in that the alertness states classification comprises four alertness state classes: the “alert” class, the “sleepy” class, and two intermediate “drowsy” classes consisting of:
a first intermediate class corresponding to a “slightly drowsy” state, defined by a number of medium duration blinks above a given threshold and below a given intermediate threshold, and by a number of long duration blinks below a given threshold,
and a second intermediate class corresponding to a “drowsy” state, defined by a number of medium duration blinks above the intermediate threshold, and by a number of long duration blinks below a given threshold.

6. The method of evaluation as claimed in claim 2 taken together characterized in that the information representative of the driver's alertness state consists of a vector of 4 alertness states of which each component represents the degree of activation of an alertness state according to the following definitions:
degree of activation of the “alert” class=f1(Σ degrees of membership in the medium duration class “M”, Σ degrees of membership in the long duration class “L”),
degree of activation of the “slightly drowsy” class=f2(Σ degrees of membership in the medium duration class “M”, Σ degrees of membership in the long duration class “L”),
degree of activation of the “drowsy” class=f3(Σ degrees of membership in the medium duration class “M”, Σ degrees of membership in the long duration class “L”),
degree of activation of the “sleepy” class=f4(Σ degrees of membership in the long duration class “L”).

7. The method of evaluation as claimed in claim 1 characterized in that:
in a preliminary phase, each alertness state class is associated with at least one duration class regarded as determinant in the temporal representation of said alertness state class.
and during the progress of an evaluation procedure:
the movements of both the driver's eyelids are analyzed and for each blink a comparison is made of the two signals representative of the movement of the two eyelids according to predetermined comparison criteria, such as criteria relating to the simultaneity, amplitude or slopes of said signals, so as to determine, for each blink, a degree of confidence ci representative of the correlation between the two signals,
and for each analysis window, each piece of information incorporating an alertness state class is associated with a degree of confidence C° to be associated with this alertness state class, such that:
C°=Σdi·ci/Σdi with:
di degree of membership of a blink in each of the duration classes selected as determinant in the temporal representation of the alertness state class,
ci degree of confidence of the blink.

8. The method of evaluation as claimed in claim 7 characterized in that, with a view to determining the degree of confidence associated with each blink, a combination of comparison criteria is used relating to the simultaneity, amplitude and slopes of the two signals representative of the movement of the two eyelids.

9. The method of evaluation as claimed in claim 2 characterized in that a regular summary is made of the information delivered at the time of the last K analysis windows, with integer K predetermined, and in that a smoothing of the corresponding data is performed so as to provide a summary vector of n alertness states of which each component consists of a mean summary value of the degree of activation of the corresponding alertness state.

10. The method of evaluation as claimed in claim 9 characterized in that, from the summary of the information delivered at the time of the last K analysis windows, a progress index is determined, by a mathematical method such as the method of least squares, representative of the progress of the driver's alertness state during the last K analysis windows.

11. The method of evaluation as claimed in claim 9 taken together, characterized in that the degrees of confidence are integrated into the information summary, so as to associate a mean value degree of confidence with each alertness state.

12. The method of evaluation as claimed in claim 1 characterized in that it further consists in integrating so-called environmental information, representative of driving conditions, such as driving time, temperature in the vehicle, time of day, type of highway (local road, freeway, city, etc.), data relating to the driver (age, experience, etc.), with a view to introducing weighting levels during diagnoses based on the analysis of eyelid movements.

13. The method of evaluation as claimed in claim 1 characterized in that it further consists in integrating information originating from behavioral observations, such as observing the direction of travel of the vehicle, with a view to introducing weighting levels during diagnoses based on the analysis of eyelid movements.

14. The method of evaluation as claimed in claim 1 characterized in that the opening of an analysis window is initiated at the time of each detection of a blink, each analysis window opened covering a specified period of time preceding said initiation.

15. The method of evaluation as claimed in claim 1 characterized in that the data of an analysis window is validated if the number of blinks detected during said analysis window is higher than a given threshold.

16. The method of evaluation as claimed in claim 2 characterized in that a classification of blink durations is set up composed of three classes corresponding to short duration “C”, medium duration “M” and long duration “L” blinks respectively.

17. The method of evaluation as claimed in claim 3 taken together characterized in that the information representative of the driver's alertness state consists of a vector of 4 alertness states of which each component represents the degree of activation of an alertness state according to the following definitions:
degree of activation of the “alert” class=f1(Σ degrees of membership in the medium duration class “M”, Σ degrees of membership in the long duration class “L”),
degree of activation of the “slightly drowsy” class=f2(Σ degrees of membership in the medium duration class “M”, Σ degrees of membership in the long duration class “L”),
degree of activation of the “drowsy” class=f3(Σ degrees of membership in the medium duration class “M”, Σ degrees of membership in the long duration class “L”),
degree of activation of the “sleepy” class=f4(Σ degrees of membership in the long duration class “L”).

18. The method of evaluation as claimed in claim 4 taken together characterized in that the information representative of the driver's alertness state consists of a vector of 4 alertness states of which each component represents the degree of activation of an alertness state according to the following definitions:
degree of activation of the “alert” class=f1(Σ degrees of membership in the medium duration class “M”, Σ degrees of membership in the long duration class “L”),
degree of activation of the “slightly drowsy” class=f2(Σ degrees of membership in the medium duration class “M”, Σ degrees of membership in the long duration class “L”),
degree of activation of the “drowsy” class=f3(Σ degrees of membership in the medium duration class “M”, Σ degrees of membership in the long duration class “L”),
degree of activation of the “sleepy” class=f4(Σ degrees of membership in the long duration class “L”).

19. The method of evaluation as claimed in claim 5 taken together characterized in that the information representative of the driver's alertness state consists of a vector of 4 alertness states of which each component represents the degree of activation of an alertness state according to the following definitions:
degree of activation of the “alert” class=f1(Σ degrees of membership in the medium duration class “M”, Σ degrees of membership in the long duration class “L”),
degree of activation of the “slightly drowsy” class=f2(Σ degrees of membership in the medium duration class “M”, Σ degrees of membership in the long duration class “L”),
degree of activation of the “drowsy” class=f3(Σ degrees of membership in the medium duration class “M”, Σ degrees of membership in the long duration class “L”),
degree of activation of the “sleepy” class=f4(Σ degrees of membership in the long duration class “L”).
